(19) United States
(12) Patent Application Publication
(10) Pub. No.: US 2013/0138350 A1
(43) Pub. Date: May 30, 2013

(54) ENHANCED TERMINATION IDENTIFICATION FUNCTION BASED ON DIP FIELD GENERATED FROM SURFACE DATA

(71) Applicants: Manoj Vallikkat Thachaparambil, Kerala (IN); Renchu Wu, Beijing (CN); Dong Wang, Beijing (CN); Rui Zeng, Beijing (CN)

(72) Inventors: Manoj Vallikkat Thachaparambil, Kerala (IN); Renchu Wu, Beijing (CN); Dong Wang, Beijing (CN); Rui Zeng, Beijing (CN)

(21) Appl. No.: 13/304,325

(22) Filed: Nov. 24, 2011

(51) Int. Cl. G06F 19/00; G01V 1/28

(52) U.S. Cl. 702/16

(57) ABSTRACT

A method for determining stratigraphic termination points from a seismic dataset, includes: deriving extremal surfaces from the seismic dataset, wherein the extremal surfaces include points that are each associated with at least one of a dip magnitude and a dip azimuth; selecting a subset of points on the extremal surfaces that meet a predetermined criterion; identifying, using a processor, a set of dip deflection points from the subset of points; defining a termination zone from the dip deflection points; defining extremal surfaces that are associated with the termination zone as associated surfaces; and determining the stratigraphic termination points based on the associated surfaces.

### CROSS-REFERENCE TO RELATED APPLICATIONS

This application relates to co-pending patent application Ser. No. ______ by Trond Brenna, entitled “Method for Stratigraphic Interpretation Using Geologic Surface Termination Identification,” which is incorporated by reference in its entirety.

### BACKGROUND OF INVENTION

1. Field of the Invention

The invention relates generally to the field of seismic data processing in relation to geophysical prospecting and seismic stratigraphic interpretation.

2. Background Art

To identify potential areas with hydrocarbon accumulations in the earth, geoscientists often employ techniques that can provide images of the geological structure of the earth's subsurface, e.g., images of subterranean formations. Such images may provide useful information relating to the nature of the formations and also may provide valuable information that may be applied to the search for hydrocarbons located within the formations. One of the most commonly employed sensing techniques is seismic imaging.

In seismic imaging, a pulse of sound waves is generated by a source (or sources) positioned at, or near, the earth's surface or in a wellbore. As the sound waves propagate into the formations, it may be partially reflected, transmitted, refracted, and/or absorbed, as it encounters the layered structure of the subterranean formations. As a result, a small portion of the energy of the sound waves is reflected back to the surface where it is recorded by receivers at or near the surface (or in a wellbore). Sound waves are sequentially reflected at different locations enabling generation of three-dimensional images of the subsurface after extensive processing of the recorded seismic data. Measurements derived from these seismic data are called seismic attributes.

The most commonly used attribute of seismic data are the amplitudes of the recorded waves because it allows for identification and interpretation of many subsurface features, such as the boundaries between different rock layers. These boundaries may be extracted by locating extremal (maximal or minimal) values of the attributes. The locations of extremal values imply impedance changes in the propagation media. Thus, these extremal values can be connected spatially to construct geologic surfaces in the 3D data volume. The study of the interplay between the geologic surfaces will give important insights into the layered characters of the subsurface and may provide valuable information for assessment of hydrocarbon potentials in a given region.

One important aspect in the field of geologic interpretation is sequence stratigraphy, which studies the evolution of the sedimentary rock formations. In stratigraphic interpretation, one tries to explain how sedimentary deposits acquire their layered characters and lithology. Through detailed study of the layers or strata within a sedimentary rock formation, key information is gathered that allows a geoscientist to make inferences about how past events (e.g., sediment accumulation, erosion, etc.) produced the present configuration of strata. Of particular interest in the field of sequence stratigraphy is the identification of sequentially related strata and the corresponding bounding unconformities, also known as stratigraphic boundaries.

A bounding unconformity (stratigraphic boundaries) may be a buried erosion surface that separates two sets of strata having different ages. The presence of an unconformity indicates that sedimentary deposition was not temporally continuous and, thus, the identification of the unconformities within a geological formation may be used to estimate the relative age between different strata. The major bounding and subdividing surfaces are commonly represented by sequence boundaries, transgressive surfaces, and maximum flooding surfaces. The intersection of sedimentary sections provides the order in which the sediments were deposited, and therefore their relative ages.

The bounding discontinuities of a sedimentary section may be identified on the basis of reflection termination patterns and their continuity. For example, stratigraphic boundaries may be defined on a seismic section by identifying the termination of seismic reflectors at their discontinuity surfaces. Terminations of seismic reflectors may occur in the following manners:
1) Terminations below a discontinuity and the definition of the upper sequence boundary. Examples of this type of terminations include: (a) Toplap, which arises from termination of strata against an overlying surface, due to non-deposition and/or erosion; and (b) Truncation surface, which results from deposition of strata and subsequent tilting and erosion along an unconformity surface.
2) Terminations above a discontinuity and the definition of the lower sequence boundary. Examples of this type of terminations include: (a) Onlap, which results form initially horizontal strata progressively terminating against an initially inclined surface; and (b) Downlap, which results from inclined strata terminating downlap against an inclined or horizontal surface.

FIG. 1 shows an example of a formation having strata 101, 103, 105, 107 and their related bounding unconformities. Within sedimentary formations, some strata may not align in the original layered orders. For example, FIG. 1 shows that strata 103 exhibit a toplap, wherein the inclined strata 103 terminate against an overlying surface 107 having a lower dip angle. At the other end, strata 103 exhibits a downlap with respect to strata 101, wherein strata 103 terminate against a lower lying surface (i.e., strata 101). FIG. 1 also shows that strata 105 terminate against strata 103 in an onlap manner, wherein the nearly horizontal strata 105 terminates against the inclined strata 103.

Knowing the locations of termination points within a formation allows for the determination of stratigraphic boundaries. Termination points may be found by locating and classifying the seismic waveform and/or amplitude anomalies constructed from determinations of phase residues in the seismic data set. See, for example, PCT Publication No. WO 2009/137150 and the discussion in Matos, et al., “Detecting Stratigraphic Discontinuities Using Time-Frequency Seismic Phase Residues,” Geophysics Vol. 76, No. 2. pp. 1-10, and the references therein.

An improvement to the methods of identifying isolated termination points is disclosed in a co-pending patent application by Trond Brenna, entitled “Method for Stratigraphic Interpretation Using Geologic Surface Termination Identification.” This application, which is incorporated by reference in its entirety, discloses methods that use added neighborhood information contained in a set of geologic surfaces to identify sequences of termination points and classify these termination points according to stratigraphic patterns.

The methods disclosed in Brenna provide reliable identification of stratigraphic termination points. However, there remains a need for methods by which areas of stratigraphic terminations can be reliably extracted from seismic datasets without also extracting terminations that are not stratigraphically relevant.

### SUMMARY OF INVENTION

One aspect of the invention relates to methods for determining stratigraphic termination points from a seismic dataset. A method in accordance with one embodiment of the invention includes: deriving extremal surfaces from the seismic dataset, wherein the extremal surfaces include points that are each associated with at least one of a dip magnitude and a dip azimuth; selecting a subset of points on the extremal surfaces that meet a predetermined criterion; identifying, using a processor, a set of dip deflection points from the subset of points; defining a termination zone from the dip deflection points; defining extremal surfaces that are associated with the termination zone as associated surfaces; and determining the stratigraphic termination points based on the associated surfaces.

Another aspect of the invention relates to systems for determining stratigraphic points. A method according to one embodiment of the invention includes a processor and a memory storing a program having instructions for causing the processor to perform the steps of: deriving extremal surfaces from a seismic dataset, wherein the extremal surfaces comprises points that are each associated with at least one of a dip magnitude and a dip azimuth; selecting a subset of points on the extremal surfaces that meet a predetermined criterion; identifying a set of dip deflection points from the subset of points; defining a termination zone from the dip deflection points; defining extremal surfaces that are associated with the termination zone as associated surfaces; and determining stratigraphic termination points based on the associated surfaces

Other aspects and advantages of the invention will be apparent from the following description and the appended claims.

### BRIEF DESCRIPTION OF DRAWINGS

FIG. 1 shows a schematic diagram illustrating examples of a sedimentary rock formation.

FIG. 2 shows an example of a workflow in accordance with one or more embodiments of the invention.

FIG. 3A-3B show examples of seismic images of subterranean formations in accordance with one or more embodiments of the invention.

FIG. 4 shows deflection points in accordance with one embodiment of the invention.

FIG. 5 illustrates a termination zone in accordance with one embodiment of the invention.

FIG. 6 shows associated surfaces and the termination zone.

FIG. 7 shows effective surface segments in accordance with one embodiment of the invention.

FIG. 8A shows stratigraphic termination points determined with a method of the invention. FIG. 8B shows the stratigraphic termination points derived using a conventional method.

FIG. 9 shows an example of a system in accordance with one or more embodiments of the invention.

FIG. 10 shows an example of a system in accordance with one or more embodiments of the invention.

FIG. 11 shows an example of a computer system in accordance with one or more embodiments of the invention.

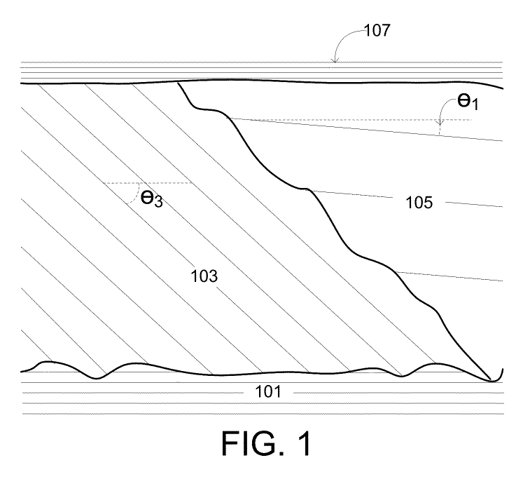

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without some of these specific details. In other instances, well-known features have not been described in detail to avoid unnecessarily complicating the description.

Embodiments of the invention relate to methods and apparatus for enhanced termination identification within seismic images. Methods of the invention use 3D surface dip cubes and surface segment selections to isolate areas of stratigraphic terminations. In addition, surface termination identification techniques, in accordance with embodiments of the invention, allow users to set criteria to extract terminations that are specific to stratigraphic boundaries. Therefore, these methods can avoid terminations that are not specific to stratigraphic boundaries.

In other words, by allowing users to set certain criteria, embodiments of the invention may extract surface terminations only at intersections that meet the user defined criteria so that any terminations that are not relevant to stratigraphic termination may be excluded. Non-stratigraphic relevant terminations may arise from lack of seismic event continuity and/or are within the same dip fields. These methods provide a higher likelihood of picking and concentrating on stratigraphically relevant terminations from 2D and 3D seismic data, even in complex structures and/or when seismic data are of poor qualities.

In accordance with embodiments of the invention, user defined criteria may include rates of dip field changes (including dip angle changes and/or dip azimuth changes). For example, a user may require a rate of dip field change to be greater or smaller than a threshold or require a rate of dip field change to fall within a window (an upper limit and a lower limit). Specifically, in accordance with embodiments of the invention, a dip-based guiding for surface termination identification may be controlled by thresholds of rates of changes in dip fields (dip angles and dip azimuths) to be within a user defined window (i.e., between an upper limit and a lower limit), or to be greater or smaller than a user selected rate of changes. In case of low dip variations between successive zones, users can fine-tune the thresholds of rates of changes in the dip fields to extract stratigraphically relevant termination points within such boundaries.

Another example of fine tunings of termination identification process may be based on user defined surface segment selections to project vectors for identifying termination patterns. This approach is particularly useful when geological events get bend and/or merge parallel, or when seismic data quality is poor at the area of intersections. In such cases, user can define the ranges of segment sizes as well as position on the filtered surface sets to compute the angular relation between surface sets that will define position and types of terminations.

Methods of the invention may be applied on 3D seismic cubes and the results can be exported as point data in 3D space so that it could be used for sharing across projects and software. Methods of the invention may be used in conjunction with other termination identification and classification methods for better results that provide higher confidence in stratigraphic termination identification from seismic data.

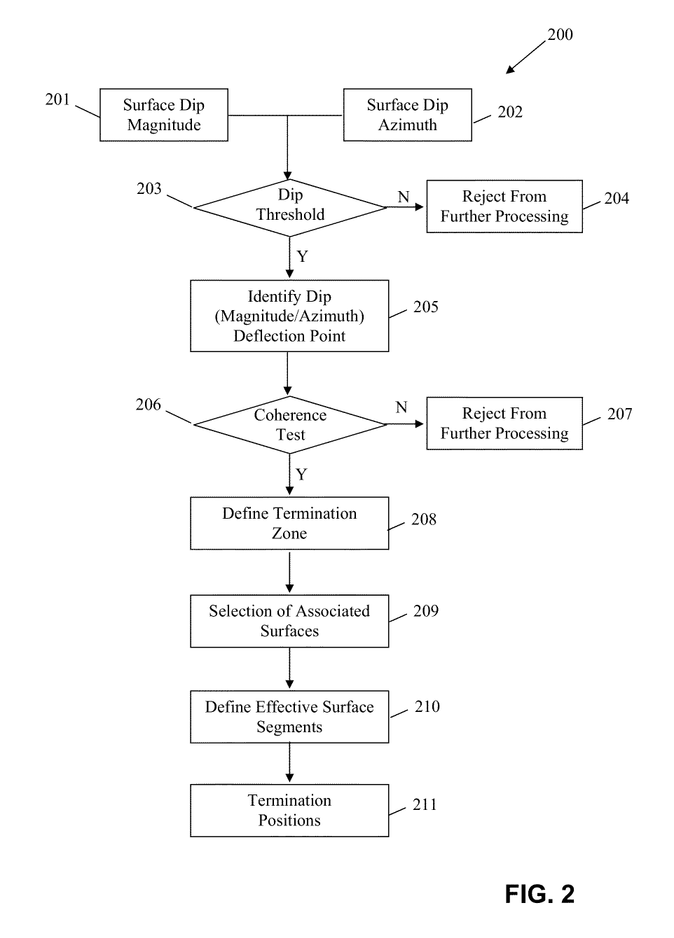

FIG. 2 shows a workflow of an exemplary method of the invention. In accordance with this example, methods of the invention may use as inputs: 1) seismic data, 2) surface dip cubes (or dip angle cubes) and/or 3) surface azimuth cubes (or dip azimuth cubes). The surface dip and azimuth attribute cubes may be derived from surfaces that have been extracted out of the seismic data, using any techniques known in the art (see e.g., U.S. Pat. No. 5,677,893, issued to de Hoop et al and assigned to Schlumberger Technology Corp.). These input data and cubes may be used in isolation or in conjunction with filtering criteria for searching termination points within a stratigraphic column

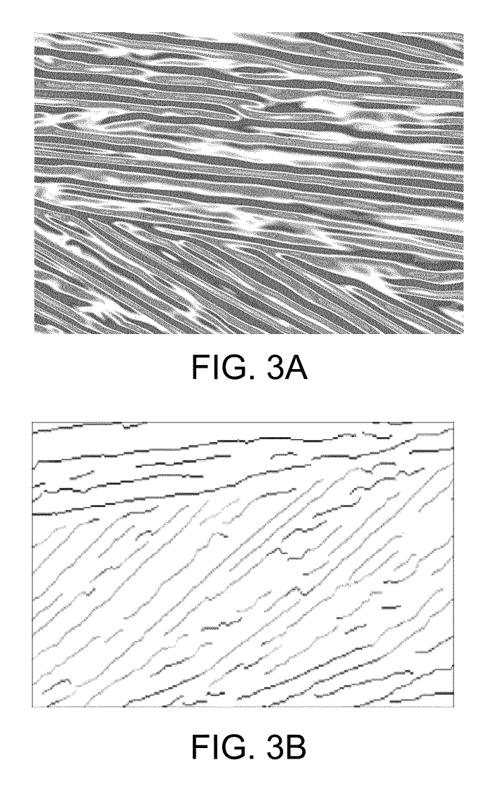

To extract surfaces from the seismic data, one may use two dimensional (2D) sections to facilitate the process. The two dimensional sections may be taken in any directions, but are preferably taken along directions aligned with depositional directions of the subsurface sedimentations. FIG. 3A shows an example of a 2D section of a 3D seismic data volume. The 2D seismic data section shows extremal surfaces. One skilled in the art would appreciate that extremal surfaces may be defined based on extrema (i.e., maxima or minima) points or zero-cross points (i.e., inflection points) of a seismic attribute (e.g., seismic signal amplitudes) derived from seismic data, according to any suitable processes known in the art. For example, the extraction may be accomplished through the use of the Extrema^{SG} software (c.f., Schlumberger Extrema^{SG} product website) or methods disclosed in U.S. Pat. No. 7,248,539 issued to Borgos, et al., which is incorporated by reference in its entirety.

In FIG. 3A, dark shading indicates a large reflected amplitude. Strong seismic reflections indicate a mismatch in acoustic impedance that occurs between sedimentary layers in the formation. Accordingly, the physical location of the surfaces that represent the interfaces between the various sedimentary layers may be extracted from the seismic data. In practice, these surfaces may be extracted by locating extremal (e.g., local maxima, minima, or inflection points) points within the 3D seismic data volume. The surfaces may then be numerically constructed by connecting the extremal points in the 3D seismic data volume.

In accordance with embodiments of the invention, dip (angle) magnitudes and/or dip azimuth data (i.e., dip cubes) associated with the extracted surfaces would be used in the processes of identification of stratigraphic terminations. To facilitate the identification of dip deflection points (to be discussed later), these dip cubes may include dip attribute values on every sample point (or a substantial number of points) on a surface. Therefore, even a single surface can have varying dip magnitude and/or azimuth distributions along the surface. FIG. 3B shows an example of a dip magnitude/azimuth cube.

In accordance with one or more embodiments, the data used for analysis may include dip angle values (magnitudes) for every sample point (or a substantial number of points) on the extremal surfaces. As used herein, this type of dataset may be termed a dip magnitude cube. Similarly, a dip azimuth cube may include the dip azimuth value for every sample point (or a substantial number of points) on the extremal surfaces. In accordance with one or more embodiments of the invention, a dip magnitude cube and a dip azimuth cube may be combined into a dip/azimuth cube that includes both the dip angle and the dip azimuth for every sample point (or a substantial number of points) on the extremal surfaces. The dip angle cubes, dip azimuth cubes, and dip/azimuth cubes may be extracted from extremal surface data that may be extracted, automatically or manually, from the 3D seismic data using methods known in the art, such as the Extrema^{SG} software package or the methods disclosed in U.S. Pat. No. 5,677,893 (issued to de Hoop et al.) discussed above.

The dip attribute cubes can be used in methods of the invention for the identification of stratigraphic terminations. As shown in FIG. 2, a method 200 may use data from extremal surfaces that comprises points having dip magnitudes 201 and/or surface dip azimuth 202 as inputs. Based on one or more user defined criteria (e.g., dip thresholds or windows), these attributes (dip magnitudes and/or dip azimuths) may be checked to see whether the data points meet the threshold requirements (step 203). The criterion may be a rate of dip magnitude changes and/or dip azimuth changes that exceed or below a threshold value or falls within an upper limit and a lower limit (i.e., a window). The rates of changes of the dip angles and/or the azimuths at a particular point, for example, may be evaluated with respect to the neighboring points.

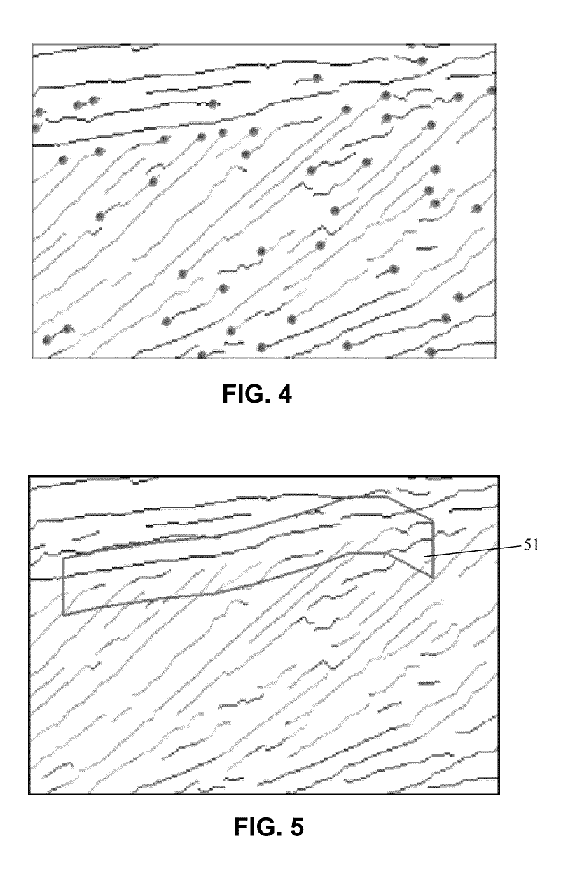

If the dip magnitudes and/or dip azimuths of extremal surface points do not meet the criterion, the data points are rejected from further processing 204. Otherwise, the data points are processed to identify dip deflection points 205. An example of deflection points identified in the dataset of FIG. 3B is shown in FIG. 4.

The dip deflection points may be identified based on changes in dip magnitudes and/or dip azimuths along an extremal surface. The dip deflection points are points where the dip fields (dip magnitude and/or azimuth) exhibit changes or reversals in the general trends of their neighboring points. One skilled in the art would appreciate that such deflection points can be identified with various techniques, including using derivatives of functions that represent the properties being examined on an extremal surface.

The dip deflection points may represent locations of stratigraphic events, sedimentation termination events, etc. Therefore, these deflections points may be treated as raw outputs of “potential” stratigraphic termination positions. However, because these deflections points may also include non-stratigraphic events, they are further processed, in accordance with embodiments of the invention, in order to identify stratigraphically relevant termination points.

In accordance with embodiments of the invention, among the raw potential stratigraphic termination positions (i.e., the deflection points described above), most probable positions are identified based on coherence of those termination points across a set of traces. The coherence test may be based on consistency with dip field trends (step 206). In other words, if dip fields (dip magnitude or dip azimuth) deviate from the general trend, then the points are not coherent. Deflection points that are not coherent are rejected from further processing 207. Coherent deflection points are then analyzed for areas that include most coherent termination points. These areas are marked as dip termination zones (step 208). An example of a dip termination zone 51 based on the deflection points of FIG. 4 is illustrated in FIG. 5.

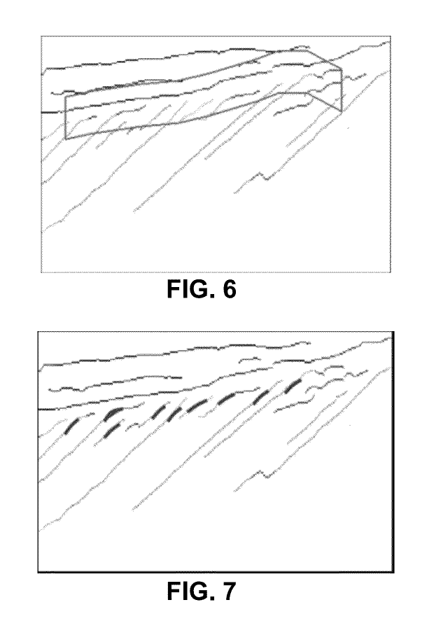

Next, surfaces that are associated with those dip termination zones are identified and filtered out for computation of terminations that are stratigraphic relevant (step 209). The associate surfaces can be identified, for example, simply as those enclosed by or touching the dip termination zones, as shown in FIG. 6. The “non-associated” surfaces may be removed to simplify subsequent analysis.

In accordance with embodiments of the invention, once the associated surfaces are selected, termination positions may be re-estimated based on selected surface segments. The surface segments may be selected by users based on the range and position of extremal positions that best represent surface dips (step 210). As noted above, the ability to select associated surface segments for “fine-tune” analysis is advantageous. For example, the influence of global or local bends of the strata may be excluded such that identification of stratigraphic terminations would be possible even if the data quality is poor. An example of such selected surface segments are shown in FIG. 7, in which the selected surface segments are marked as thick segments.

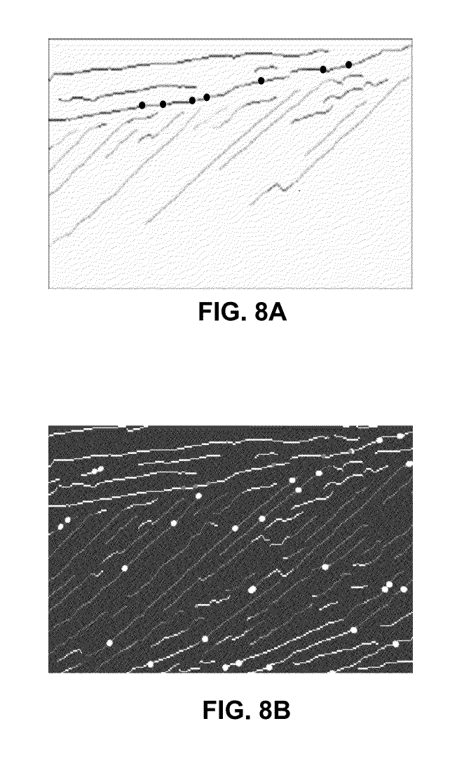

In accordance with embodiments of the invention, the selected surface segments may be used to re-estimate the termination points, for example by using vector analysis to identify and classify the termination points (step 211). In vector analysis, the selected surface segments is treated as vectors. Then, the projection (or extrapolation) of these vectors onto the intersection strata would mark the termination points of these surface segments. The termination points thus identified would be free of interference of local surface dip variations close to the intersection plane. Therefore, these terminations points would mark the locations of stratigraphically relevant terminations. These locations may be plotted on the data display (as shown in FIG. 8A), in which the termination positions are marked as solid dots.

The exemplary method as outline in FIG. 2 represents a constrained workflow of termination point selections. Such methods significantly improve conventional termination identification methods that largely depend on surface edges and vector projections. When seismic data are of poor quality or the events are highly discontinues and noisy, the conventional methods may produce large numbers of non-stratigraphic terminations that result from edges of discontinuous events within same stratigraphic package. FIG. 8B shows termination points obtained by conventional methods. The termination points in FIG. 8B include many that are not related to stratigraphic terminations. A comparison between FIG. 8A and FIG. 8B clear shows that a method of the invention can more reliably identify termination points that are stratigraphically relevant and avoid identifying termination points that are not stratigraphically relevant.

While the workflow illustrated in FIG. 2 includes many steps, one skilled in the art would appreciate that some of these steps may be omitted without departing from the scope of the invention. For example, one may skip the selection of effective surface segments and use the associate surfaces instead for the calculation of the termination points.

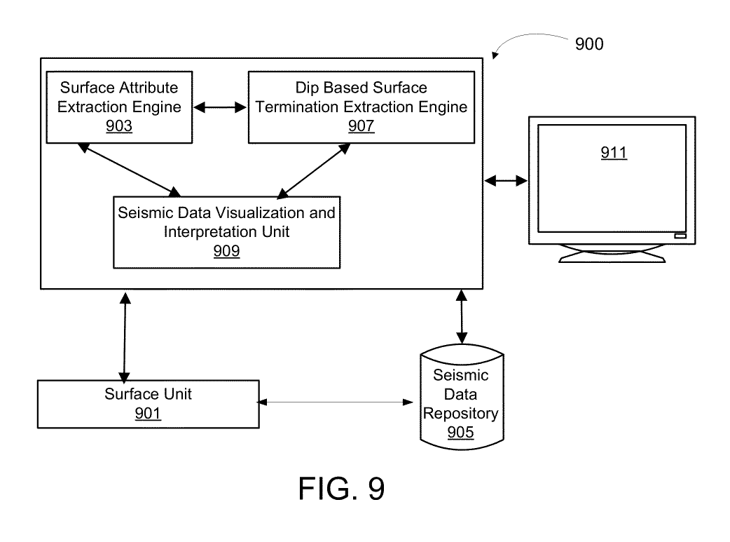

Some embodiments of the invention relate to systems for performing termination identification according to methods described above. FIG. 9 shows a schematic diagram of an exemplary surface termination identification system 900 for identifying stratigraphic termination points in a seismic dataset in accordance with one or more embodiments of the invention. In one or more embodiments, one or more of the modules and elements shown in FIG. 9 may be omitted, repeated, and/or substituted. Accordingly, embodiments of enhanced termination identification based on dip field generated from surface data should not be considered limited to the specific arrangements of modules shown in FIG. 9.

As shown in FIG. 9, the system may include a surface unit 901, a surface attribute extraction engine 903, a seismic data repository 905, a dip based surface termination extraction engine 907, a seismic data visualization and interpretation unit 909, and an optional display 911. In accordance with one or more embodiments, surface unit 901, surface attribute extraction engine 903, seismic data repository 905, dip based surface termination extraction engine 907, seismic data visualization and interpretation unit 909, and display 911 may be operatively and/or communicatively linked. Accordingly, every component may send, receive, or otherwise exchange data with every other component. Each of these components is described in more detail below.

In accordance with one or more embodiments of the invention, surface unit 901 may be used to communicate with tools (such as seismic logging equipment) and/or offsite operations (not shown). Data gathered by sensors, e.g., geophones (not shown), may be collected by the surface unit and/or other data collection sources for analysis and other processing. The data outputs may be stored in a seismic data repository 905 which may be any type of storage unit and/or device (e.g., a file system, database, collection of tables, or any other storage mechanism) for storing data.

FIG. 9 further includes surface attribute extraction engine 903 configured to extract surface attributes from the seismic data, thereby creating surface attribute datacubes. For example, surface attribute extraction engine 903 may extract the surfaces that represent the set of boundaries between different rock layers. In addition, the surface attribute extraction engine 903 may extract the local dip angle and dip azimuth for each point (or a substantial number of points) included in the extracted surface. One of ordinary skill in the art would recognize that the surface attribute extraction engine 903 may be configured to employ any surface attribute extraction technique known in the art for extracting any number of known surface attributes. For example, surface attribute extraction engine 903 may employ the techniques used in the Extrema^{SG} software package sold by Schlumberger, or, for example, the techniques disclosed in U.S. Pat. No. 7,248,539.

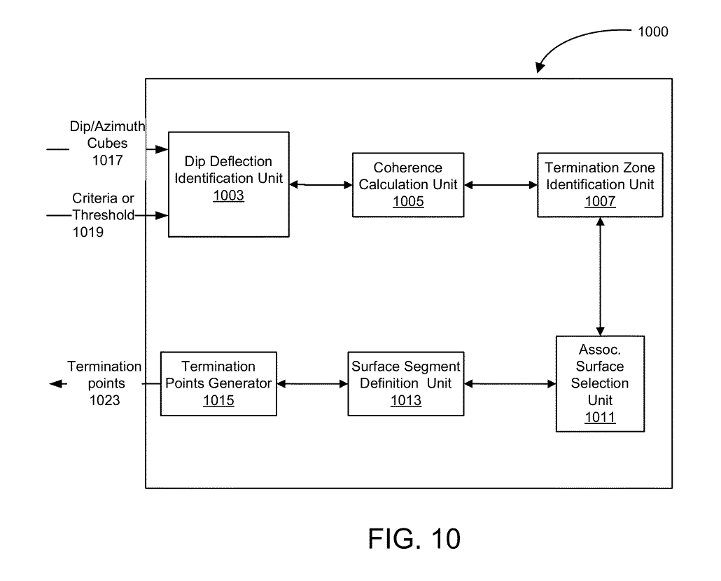

FIG. 9 further includes dip based surface termination (DBST) extraction engine 907. DBST extraction engine 907 is configured to extract the stratigraphic termination points from a set of extracted surfaces produced by surface attribute extraction engine 903. Furthermore, DBST extraction engine 907 may extract the stratigraphic termination points using a threshold condition that depends on the local dip angle and/or dip azimuth of a point in the datacube. DBST extraction engine 907 is described in more detail below in reference to FIG. 10.

FIG. 9 further includes seismic data visualization and interpretation (SDVI) unit 909. SDVI unit 909 processes the data into a form that allows a user to view and interact with the seismic data. Specifically, the SDVI unit 909 includes functionality to generate an annotated seismic image of a subterranean formation having various surface attributes overlaid on the image (as discussed below).

In accordance with one or more embodiments of the invention, the SDVI unit 909 includes a graphical user interface (GUI) for interacting with the user. The GUI includes functionality to detect commands from a user and update the seismic image accordingly. For example, in one or more embodiments of the invention, the GUI includes functionality to receive a set of numbers corresponding to the bounding coordinates of a region-of-interest (ROI) within the seismic image (i.e., a subset of the image). SDVI unit 909 may receive this user defined ROI and update either the image and/or the surface attribute extraction routines to display (e.g., via display 911) and/or extract surface attributes within the user defined ROI. Further, in one or more embodiments of the invention, the GUI may include various user interface components, such as buttons, checkboxes, drop-down menus, etc. Accordingly, a user with minimal computer and/or specialized knowledge relating to seismic data analysis may analyze the seismic image using the SDVI unit 909 in accordance with one or more embodiments of the invention.

Surface termination identification system 900 may further include a display 911 that presents the seismic data, including extracted surface attributes to a user. The display may be a monitor (e.g., Cathode Ray Tube, Liquid Crystal Display, touch screen monitor, etc.) or any other object that is capable of presenting data.

FIG. 10 shows a schematic diagram of a DBST extraction engine 1000 in accordance with one or more embodiments of the invention. In this example. the DBST extraction engine 1000 includes preconditioning unit 1003, coherence calculation unit 1005, termination identification unit 1007, surface selection unit 1011, surface segment definition unit 1013, and termination position generator 1015.

The preconditioning unit 1003 takes as input user defined dip angle and/or dip azimuth thresholds 1017, a surface attribute datacube 1019, which include dip magnitude and azimuth information, and user defined ROI coordinates 1021. An example of a subterranean formation surface attribute datacube in the form of a dip/azimuth datacube is shown fin FIG. 3B. The surface attribute datacube may be special because every sample point (or a substantial number of points) on the surface includes dip attribute values (e.g., dip angles and/or azimuths). Therefore, even a single surface may have varying dip angles and sip azimuth distributions along it.

The preconditioning unit 1003 may be configured select extremal surfaces within the user defined ROI that satisfy the user defined dip angle and/or dip azimuth thresholds. Further, the thresholds may be rates of change of the dip field (i.e., dip angle and dip azimuth) within a user defined window. The set of selected surfaces are then analyzed for dip deflection points, based on the changes in the dip magnitudes and/or azimuths. These dip deflection points serve as raw output data comprising a set of potential stratigraphic termination positions. An example of the surface attribute datacube including the identified termination points (shown as filled circles) is shown in FIG. 4.

Among these potential stratigraphic termination position, the most probable positions are identified based on the coherence of these terminations across a set of traces, consistent with the dip field trend. This may be performed by the coherence calculation unit 1005. The termination zone identification unit 1007 identifies dip termination zones as areas having the most coherent termination points. These zones are highlighted as probable dip termination zones. FIG. 5 shows an example of an identified dip termination zone.

The surface selection unit 1011 selects surfaces that are associated with the dip termination zones. FIG. 6 shows an example of a set of the associated surfaces. The set of associated surfaces may then be passed to the surface segment definition unit 1013. In accordance with one or more embodiments, the surface segment definition unit 1013 includes a user interface that allows for the user to identify surface segments for vector analysis and classification. In accordance with one or more embodiments, the surface segments include user defined portions (e.g., the range and position) of the selected extremal surfaces that best represent the prevailing surface dips. FIG. 7 shows an example of selected surfaces having user defined surface segments.

Finally, the termination position generator generates a set of stratigraphic termination points along the terminating surface according to the defined surface segments, independent of the local surface dip variations close to the terminating surface. FIG. 8A shows an example of the generated set of stratigraphic termination points, which are illustrated as black dots.

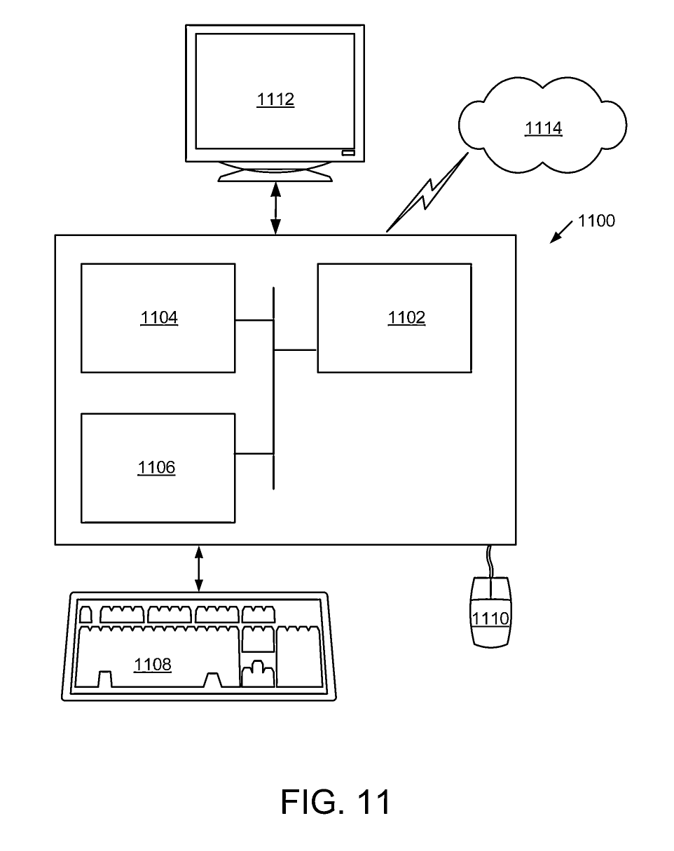

Embodiments of the invention may be implemented on virtually any type of computer regardless of the platform being used. For example, as shown in FIG. 11, a computer system (1100) includes one or more processor(s) (1102), associated memory (1104) (e.g., random access memory (RAM), cache memory, flash memory, etc.), a storage device (1106) (e.g., a hard disk, an optical drive such as a compact disk drive or digital video disk (DVD) drive, a flash memory stick, etc.), and numerous other elements and functionalities typical of today's computers (not shown). The computer (1100) may also include input means, such as a keyboard (1108), a mouse (1110), or a microphone (not shown). Further, the computer (1100) may include output means, such as a monitor (1112) (e.g., a liquid crystal display (LCD), a plasma display, or cathode ray tube (CRT) monitor). The computer system (1100) may be connected to a network (1114) (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms. Generally speaking, the computer system (1100) includes at least the minimal processing, input, and/or output means necessary to practice embodiments of the invention.

Further, those skilled in the art will appreciate that one or more elements of the aforementioned computer system (1100) may be located at a remote location and connected to the other elements over a network. Further, embodiments of the invention may be implemented on a distributed system having a plurality of nodes, where each portion of the invention (e.g., display, formation data, analysis device, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for determining stratigraphic termination points from a seismic dataset, comprising:
deriving extremal surfaces from the seismic dataset, wherein the extremal surfaces comprises points that are each associated with at least one of a dip magnitude and a dip azimuth;
selecting a subset of points on the extremal surfaces that meet a predetermined criterion;
identifying, using a processor, a set of dip deflection points from the subset of points;
defining a termination zone from the dip deflection points;
defining extremal surfaces that are associated with the termination zone as associated surfaces; and
determining the stratigraphic termination points based on the associated surfaces.

2. The method of claim 1, wherein the defining a termination zone from the dip deflection points comprises first selecting a subset of dip deflection points that are coherent and then defining the termination zone from the subset of the dip deflection points.

3. The method of claim 1, wherein the determining the stratigraphic termination points based on the associate surfaces comprises first defining effective surface segments on the associated surfaces and then determining the stratigraphic termination points from the effective surface segments.

4. The method of claim 1, wherein the criterion is a rate of change of the dip magnitude or the dip azimuth.

5. The method of claim 1, wherein the identifying the set of dip deflection points is based on changes in dip magnitude or dip azimuth along an extremal surface.

6. The method of claim 1, wherein the determining the stratigraphic termination points is performed with vector analysis, wherein the associated surfaces are treated as vectors and the vectors are projected onto intersecting strata to obtain the stratigraphic termination points.

7. The method of claim 1, wherein the extremal surfaces are derived from the seismic dataset based on maxima, minima, or inflection points of magnitudes of seismic signals.

8. A system comprising a processor and a memory storing a program having instructions for causing the processor to perform the steps of:
deriving extremal surfaces from a seismic dataset, wherein the extremal surfaces comprises points that are each associated with at least one of a dip magnitude and a dip azimuth;
selecting a subset of points on the extremal surfaces that meet a predetermined criterion;
identifying a set of dip deflection points from the subset of points;
defining a termination zone from the dip deflection points;
defining extremal surfaces that are associated with the termination zone as associated surfaces; and
determining stratigraphic termination points based on the associated surfaces.

9. The system of claim 8, wherein the defining a termination zone from the dip deflection points comprises first selecting a subset of dip deflection points that are coherent and then defining the termination zone from the subset of the dip deflection points.

10. The system of claim 8, wherein the determining the stratigraphic termination points based on the associate surfaces comprises first defining effective surface segments on the associated surfaces and then determining the stratigraphic termination points from the effective surface segments.

11. The system of claim 8, wherein the criterion is a rate of change of the dip magnitude or the dip azimuth.

12. The system of claim 8, wherein the identifying the set of dip deflection points is based on changes in dip magnitude or dip azimuth along an extremal surface.

13. The system of claim 8, wherein the determining the stratigraphic termination points is performed with vector analysis, wherein the associated surfaces are treated as vectors and the vectors are projected onto intersecting strata to obtain the stratigraphic termination points.

14. The system of claim 8, wherein the extremal surfaces are derived from the seismic dataset based on maxima, minima, or inflection points of magnitudes of seismic signals.

15. A non-transitory computer readable medium storing a program having instructions for causing a processor to perform the steps of:
deriving extremal surfaces from a seismic dataset, wherein the extremal surfaces comprises points that are each associated with at least one of a dip magnitude and a dip azimuth;
selecting a subset of points on the extremal surfaces that meet a predetermined criterion;
identifying a set of dip deflection points from the subset of points;
defining a termination zone from the dip deflection points;
defining extremal surfaces that are associated with the termination zone as associated surfaces; and
determining stratigraphic termination points based on the associated surfaces.

16. The non-transitory computer readable medium of claim 15, wherein the defining a termination zone from the dip deflection points comprises first selecting a subset of dip deflection points that are coherent and then defining the termination zone from the subset of the dip deflection points.

17. The non-transitory computer readable medium of claim 15, wherein the determining the stratigraphic termination points based on the associate surfaces comprises first defining effective surface segments on the associated surfaces and then determining the stratigraphic termination points from the effective surface segments.

18. The non-transitory computer readable medium of claim 15, wherein the criterion is a rate of change of the dip magnitude or the dip azimuth.

19. The non-transitory computer readable medium of claim 15, wherein the identifying the set of dip deflection points is based on changes in dip magnitude or dip azimuth along an extremal surface.

20. The non-transitory computer readable medium of claim 15, wherein the determining the stratigraphic termination points is performed with vector analysis, wherein the associated surfaces are treated as vectors and the vectors are projected onto intersecting strata to obtain the stratigraphic termination points.
